(19) United States
(12) Patent Application Publication
(10) Pub. No.: US 2003/0061746 A1
(43) Pub. Date: Apr. 3, 2003

(54) Moving-character sound structure

(76) Inventor: Ching Yang Huang, Chu Pei City (TW)

Correspondence Address: BACON & THOMAS, PLLC, 625 SLATERS LANE, FOURTH FLOOR, ALEXANDRIA, VA, 22314

(21) Appl. No.: 09/964,523

(22) Filed: Sep. 28, 2001

(51) Int. Cl. G09F 19/08

(52) U.S. Cl. 40/411

(57) ABSTRACT

This invention is a moving-character sound structure, involving mainly a mechanical unit. On the surface of the mechanical unit is an animal character. The eyes and mouth of the character are movable. The eyes and mouth of the character are connected to a transmission mechanism composed of a swing rod, a spring and a motor. Inside the mechanical unit are various circuits for radio, tape recorder, vocal IC, karaoke, and a driving circuit. When the push keys on the mechanical unit are pushed to select specific sound function giving off sound, the driving motor analyzes the specific frequency and activates the motor to rotate intermittently, causing the eyes and mouth of the character to open and close intermittently.

### BACKGROUND OF THE INVENTION

This invention relates to a moving-character sound structure, particularly to a sound structure involving a character's eyes and mouth to move according to the changes of sound frequencies.

Conventionally, a radio set, tape recorder or such sound appliances generally has regular control push-keys for optional functions on the casing, giving off music or songs from its speakers. There are no other features in such conventional sound appliances than listening to its sound or voice. The monotone exterior of the conventional sound appliances feels icy cold to the listener, lacking a sense of amusement that may accompany to the listening.

### BRIEF DESCRIPTION OF THE INVENTION

The main objective of this invention is to provide a moving-character sound structure, comprising a mechanical unit, on the surface of the mechanical unit is an animal character with movable eyes and mouth. The eyes and mouth of the character are connected to a transmission mechanism that is composed of a swing rod, a spring and a motor. Inside the mechanical unit are various circuits for radio, tape recorder, vocal IC, karaoke and such functions, and a driving circuit. The driving circuit will analyze the specific frequency of the sound/voice, and drives the motor to rotate intermittently, causing the eyes and mouth of the character to open and close intermittently according to changing voices/sounds, adding much fun to the sound effects.

### BRIEF DESCRIPTION OF DRAWINGS

The drawings of preferred embodiments of this invention are described in following details to enable better understanding.

FIG. 1 is a perspective view of the invention.

FIG. 2 is a schematic view of the driving mechanism in this invention.

FIG. 3 is a block diagram of the invention.

FIG. 4 is a wiring diagram of the invention of radio.

FIG. 5 is an embodiment view of the invention in action.

### DETAILED DESCRIPTION OF PREFERRED EMBODIMENTS

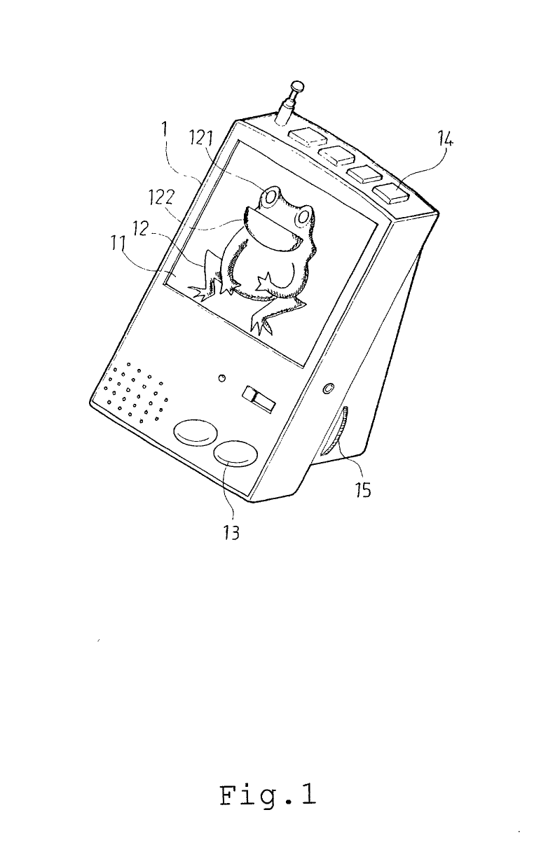

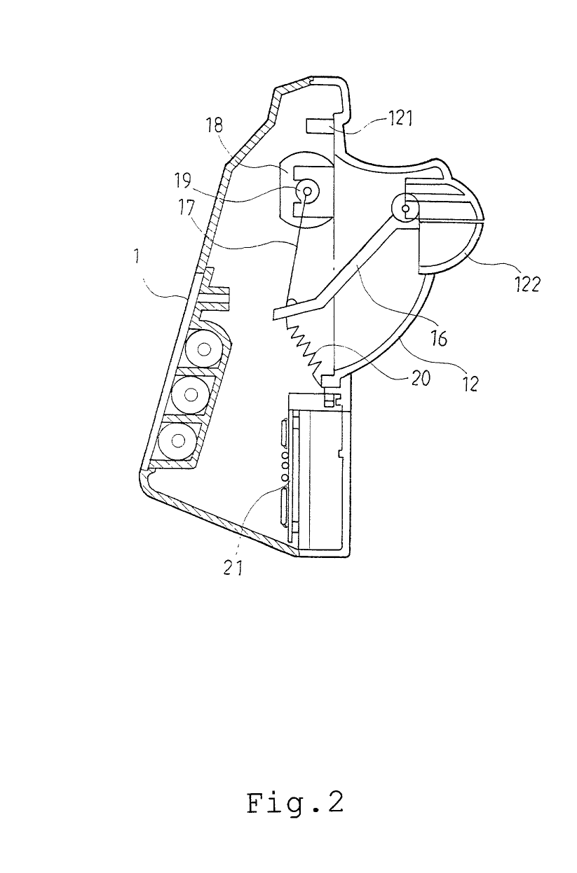

As shown in FIGS. 1 and 2, this invention involves mainly a mechanical unit 1, on the surface of the mechanical unit 1 is a display window 11, inside the display window 11 is a three-dimensional animal character. On the surface of the mechanical unit 1 are push keys for optional functions, control, volume control, etc. for various sound effects such as radio, tape recorder, vocal IC and karaoke performances.

The character 12 has eyes 121 and a mouth 122 that are respectively connected to a driving mechanism 10. In this embodiment, a mouth 122 is used as an example, which is connected to a curved swing rod 16. The end of the swing rod 16 is connected by a connecting rod 17 to a rotating disc 19 that is framed to the driving shaft of a motor 18. The bottom end of the swing rod 16 is connected by a spring 20 to the bottom of the mechanical unit 1, so that when the motor 16 swings up and down, the mouth 122 will open and close correspondingly.

Inside the mechanical unit 1 is a circuit board that is composed of circuits for radio, tape recorder, vocal IC and drivers. The circuit board 21 is connected to the motor 18 in a way that when any sound effect is activated, the frequency analyzed by the driving circuit will activate the motor 18 to rotate, which in turn drives the mouth 122 of the character 12 to open and close with changing sound frequencies, adding the effect of fun and amusement.

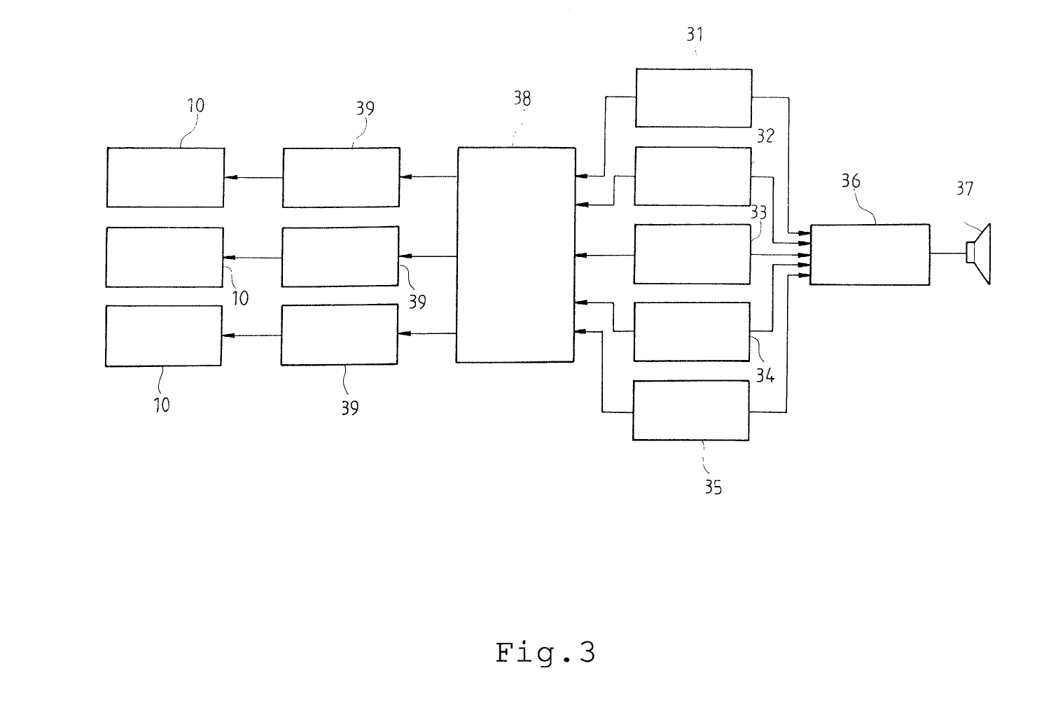

As shown in FIG. 3, the electrical circuit of this invention comprises a sound control circuit 31, a radio circuit 32, a tape recorder circuit 33, a vocal IC circuit 34 and a sound recording IC circuit 35. The circuits are respectively connected to an amplifier 36, through which a speaker 37 gives out the sound and/or voice. The circuits are also respectively connected to an optional sound frequency, control circuit 38, to enable selection of various sound inputs, which are transmitted through various outputs of circuits 39 to analyze specific frequencies, to drive different driving mechanisms 10 and produce intermittent movements of the eyes 121, mouth 121 or other parts of the character 12.

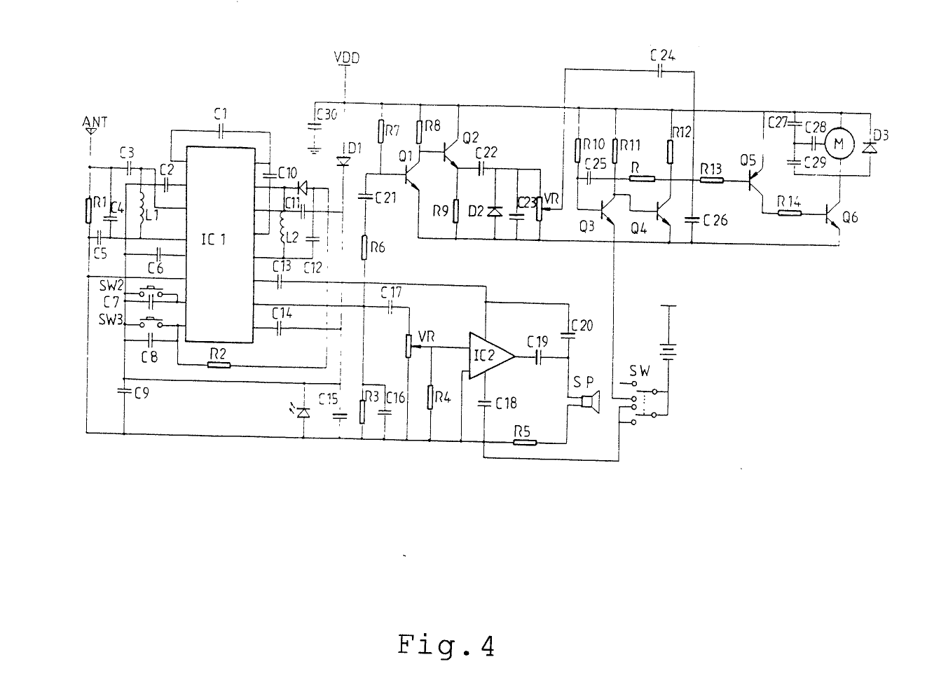

FIG. 4 illustrates the wiring diagram of the radio circuit 32 for the preferred embodiment of this invention. This invention has a single-chip integrated circuit IC1 to compose signal reception of high or medium radio frequencies. The sound signals so received are amplified by IC2 before they are transmitted through the speaker. The sound signals are also transmitted to a driver circuit that is composed of Q1 and Q2 crystals, for analysis of specific frequencies, before they are amplified by Q5 and Q6 crystals, to drive the motor to rotate.

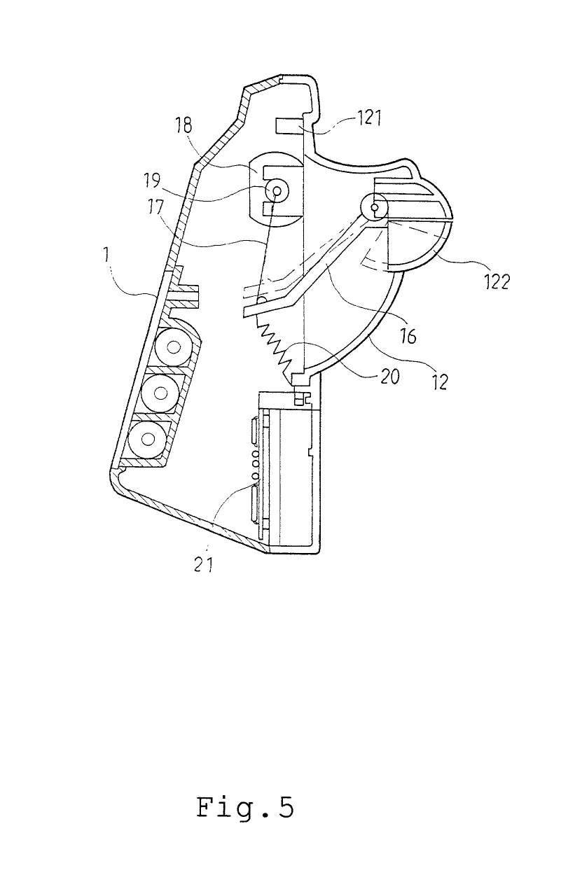

As shown in FIGS. 3 and 5, when this invention is put to application, the required function is selected, so the speaker 37 sends out the sound from said function. Take the radio function as an example, when the broadcast sound or music is activated, the circuit will conduct analysis to produce intermittent rotation of the motor 18, which result accordingly in intermittent up and down movement of the swing rod 16, causing the mouth 122 of the character 12 to open and close according to changing voices, adding much fun when the listener is listening to the radio.

To conclude, this invention is a novelty creation based on a practical design involving control circuits and driving mechanisms, to activate the eyes and mouth of a three-dimensional character to move with changing voices/sound, and create special fun of animation.

What is claimed is:

1. A moving-character sound structure, comprising:
a mechanical unit, on which surface being a display window, inside said display window being a three-dimensional character in the configuration of an animal, the eyes, mouth and other parts of said character being able to move, said parts being connected to driving mechanisms;
a transmission mechanism, having a curved swing rod, the front end of the swing rod being connected to the moving parts of the character, a part near the end being connected by a connecting rod to a rotating disc that is framed to the driving shaft of the motor, the bottom end near the end of the swing rod being connected by a spring to the bottom of the mechanical unit; and
a driving circuit, providing specific frequencies for analysis of the sounds/voices, to drive the motor to rotate intermittently;
which are so assembled in a way that, when the driving circuit drives the motor to move intermittently, the swing rod will move up and down, causing the eyes, mouth and other parts of the character to open and close, adding much fun when the user is listening to radio or other musical effects.

2. The moving-character sound structure as claimed in claim 1, wherein, said driving circuit is connected to various functions, such as radio, tape recorder, vocal IC, sound recording IC circuit, karaoke device, etc. to take up specific frequencies of different sound signals.
